(19) United States
(12) Patent Application Publication
(10) Pub. No.: US 2009/0129403 A1
(43) Pub. Date: May 21, 2009

(54) Fueling Facility Communication

(76) Inventors: Daniel C. Harrell, Round Rock, TX (US); Thomas P. Tooley, Alpharetta, GA (US)

Correspondence Address: FISH & RICHARDSON P.C., P.O. BOX 1022, MINNEAPOLIS, MN, 55440-1022, US

(21) Appl. No.: 11/943,384

(22) Filed: Nov. 20, 2007

(51) Int. Cl. H04J 3/22; G06Q 20/00

(52) U.S. Cl. 370/467; 705/16

(57) ABSTRACT

Systems, methods, and devices may provide for communications at a fueling facility. In one general aspect, a system, device, or technique for a fuel dispenser may include the ability to receive a signal including information in a first communication protocol and information in a second communication protocol, separate the signal into the first communication protocol and the second communication protocol, and process the signals in the first and second communication protocols.

### TECHNICAL FIELD

This invention relates to communications and, more particularly, to providing communications in a fueling environment.

### BACKGROUND

The retail petroleum industry utilizes various types of fuel dispensers for dispensing fuel to customers. Some form of remote dispenser controller is typically used for controlling the fuel dispensers. The controller is typically on the same premises as the fuel dispensers and coupled to an interface unit so that a site attendant can monitor and control particular fuel dispensers from a building at the site (e.g., a store). The dispenser controller sends data signals (e.g., commands) to the fuel dispensers. The data may include price, payment data for the fuel dispensed, preset amounts of fuel to dispense, and authorization to dispense fuel. The fuel dispensers likewise send data signals to the controller, including pump number, pump status, and dispensed fuel volume and sale value.

An example of one type of service that a dispenser controller commonly provides to a fuel dispenser is point-of-sale (POS). POS services may, for example, include cash register, dispenser control, credit card, inventory management, processing, and scanning. POS services are commonly implemented in a dispenser controller utilizing an open architecture hardware platform with POS application software programming to integrate the services.

In recent years, fueling facilities have evolved into elaborate systems capable of providing a wide variety of customer services, such as fuel dispensing, car washing, ATM access, money order access, and credit card or debit card transactions. Additionally, it has become desirable to present advertisements, purchase opportunities, and other information to customers interacting with the fueling facility (e.g., while pumping fuel) for customer convenience and additional revenue stream.

In order to provide these advanced data features at fueling facilities, advanced communication systems are generally required. For instance, Category 5 cabling or other high-speed communication lines capable of providing high-speed content may be installed. To securely install these communication lines, fueling facility operators typically bury the communication lines (e.g., in concrete) between the fuel dispensers and the dispenser controller. Fuel dispensers and dispenser controllers may also require advanced components in order to correctly receive these new forms of information.

### SUMMARY

Systems, methods, and devices may provide for communications at a fueling facility. In one general aspect, a fuel dispenser may include a management module for controlling the functions of the fuel dispenser, a multiplexing device coupled to the management module, a device manager, a first dispenser component (e.g., a card reader), and a second dispenser component (e.g., a display). The multiplexing device may be adapted to receive a composite signal comprising a first set of information in a first communication protocol (e.g., RS-485) and a second set of information in a second protocol (e.g., Ethernet), separate the composite signal into the first and second set of information, and transmit the first and the second set of information to the management module.

The device manager may be coupled to the management module and adapted to receive commands generated by the management module, wherein the commands are generated in response to the first and second sets of information. The device manager may also be adapted to translate at least one of the commands into a first operational command for the first fuel dispenser component, the first operational command formatted according to a third communication protocol. Further, the device manager may also be able translate at least one of the commands into a second operational command for the second fuel dispenser component, the second operational command formatted according to a fourth communication protocol. The first fuel dispenser component may be coupled to the device manager and adapted to receive and perform the first operational command while the second fuel dispenser component may also be coupled to the device manager and adapted to receive and perform the second operational command.

In some instances, the first communication protocol may be the same as the third communication protocol while the second communication protocol may be the same as the fourth communication protocol. In other instances, the first communication protocol may not be the same as the third communication protocol and the second communication protocol may not be the same as the fourth communication protocol. Additionally, in some instances, the multiplexing device may demultiplex, or separate, the first and second sets of information using frequency-division multiplexing. The multiplexing device may also be further adapted to receive a composite signal comprising information in more than two communication protocols.

In another general aspect, a communication method for a fueling facility may include generating a first set of information in a first communication protocol and a second set of information in a second communication protocol at a facility manager. In some examples, the first communication protocol may be RS-485 and the second communication protocol may be Ethernet. The method may also include combining the first set of information in the first communication protocol and the second set of information in the second communication protocol into a combined signal at the facility manager and transmitting the combined signal from the facility manager to a fuel dispenser (e.g., across a twisted pair of wires). The method may also include receiving the combined signal at the fuel dispenser and separating the combined signal into the first set of information in the first communication protocol and the second set of information in the second communication protocol. Further, the method may include processing the first and second set of information at the fuel dispenser.

In certain implementations, combining and separating the first and second set of information may include using multiplexing techniques on the first and second set of information. In some examples, the multiplexing techniques may include frequency-division multiplexing.

Systems, methods, and devices for fuel dispenser communications may have a variety of features. For example, as operators demand better performance and greater capabilities in their fueling facilities, fuel dispensers and controllers may be modified to increase the speed, amount, and types of data communicated between the locations without having to undertake cumbersome structural changes. In one example, advertisements, multimedia, and other advanced communications may be desired at the fuel dispenser. An architecture and technique for transmitting legacy data and advanced information across the legacy communication lines without adding a dedicated communication line between the components for advanced communications may provide the increased functionality and communications desired.

Some or all of these aspects may be further included in respective systems or other devices for executing, implementing, or otherwise supporting suitable communications. The details of one or more implementations are set forth in the accompanying drawings and the description below. Other features will be apparent from the description and drawings, and from the claims.

### DESCRIPTION OF DRAWINGS

FIG. 1 is a block diagram illustrating a system architecture for a fueling environment in accordance with one implementation of the present disclosure;

FIG. 2 is a sequence diagram illustrating one example of a process of communicating legacy and Ethernet data across a legacy communication line at a facility manager within the illustrated environment of FIG. 1;

FIG. 3 is a sequence diagram illustrating one example of a process of communicating legacy and Ethernet data across a legacy communication line at a fuel dispenser within the illustrated environment of FIG. 1; and

FIG. 4 is a flow diagram illustrating one example of a process for receiving legacy and Ethernet data across a legacy communication line at a fuel dispenser within the illustrated environment of FIG. 1.

### DETAILED DESCRIPTION

Efficiency, safety, and profitability for fueling facilities may be improved by intelligent control of fuel dispensers. These benefits may apply not only to the actual dispensing of fuel at a fuel dispenser, but also to the customer to which the fuel is being dispensed. In particular implementations, a fueling facility process and/or system may include the ability to provide enhanced information, including advertising and additional retail opportunities, by providing enhanced communications between a facility manager and the one or more fuel dispensers. The enhanced communications may, for example, provide media to the one or more fuel dispensers, point-of-sale functions, fuel dispenser coordination, fuel dispenser diagnostics, data security, and sales capabilities for remote merchants. Other implementations may include one or more of these features as well as additional features.

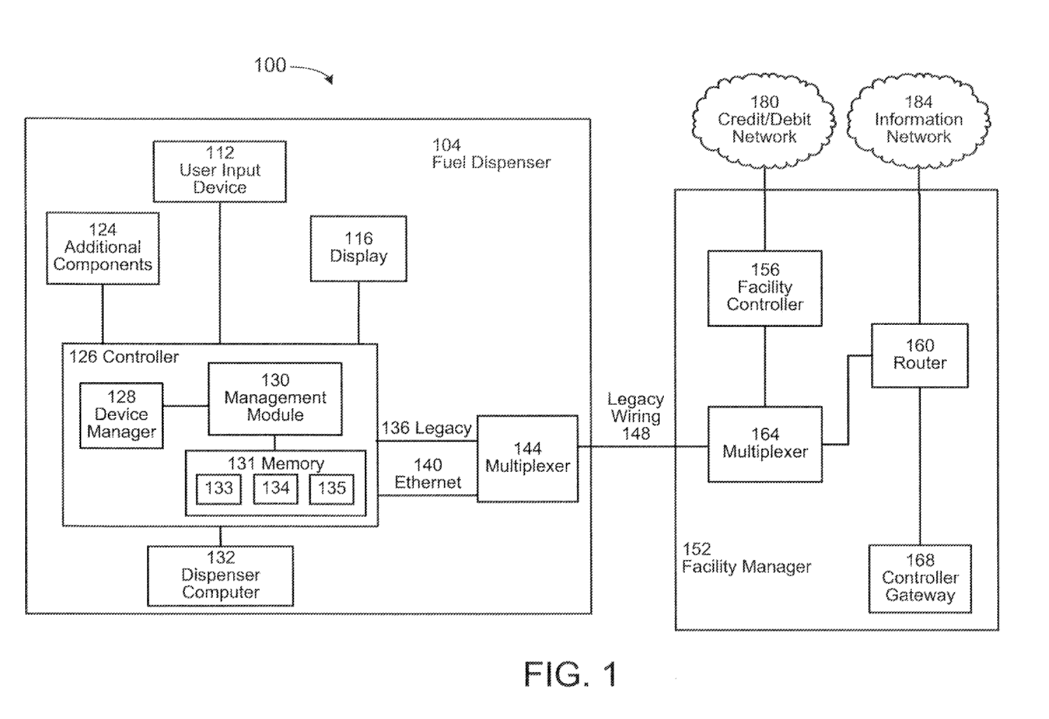

FIG. 1 illustrates one implementation of a system architecture for a fueling facility 100. Fueling facility 100 includes a fuel dispenser 104, a facility manager 152, and a legacy communication line 148 for communicating data between the fuel dispenser 104 and the facility manager 152, wherein the legacy communication line 148 comprises legacy wiring. While FIG. 1 illustrates a single fuel dispenser 104, it should be realized that the facility manager 152 may be interconnected with multiple fuel dispensers in a normal fueling environment 100. The fuel dispenser 104 within the present environment 100 may be a dumb device which is fully dependent upon commands transmitted to the fuel dispenser 104 from the facility manager 152 for proper operations. In other instances, the fuel dispenser 104 may be capable of performing various functions of the fuel dispenser 104 without receiving specific commands from the facility manager 152.

In general, communications from the facility manager 152, which are sent across the legacy communication line 148, may supply various commands, instructions, data, and other information to the fuel dispenser 104 in order to perform fueling-related operations. In the present implementation, the legacy communication line 148 may be a serial communication line, such as an RS-422 or RS-485 serial communication line, or a twisted pair of wires. Serial communications have provided the basic communications and functionality for previous iterations of fueling environments.

In more detail, fuel dispenser 104 may be a fuel dispenser, a fuel pump, or any other appropriate fuel dispensing apparatus. Fuel dispenser 104 may have single or multiple hose configurations. Depending on its configuration, fuel dispenser 104 may dispense one or more products (e.g., gasoline and diesel). The fuel dispenser 104 typically operates in cooperation with the facility manager 152 to dispense fuel. In doing so, the fuel dispenser 104 may recognize when a customer is present (e.g., by detecting activation of an input device or removal of a pump handle) and notify facility manager 152, which may then obtain payment information from the customer, authenticate the customer, and allow fuel dispensing to begin. The fuel dispenser 104 may also communicate the dispensed amount of fuel to the facility manager 152, which may complete the sales transaction when the customer is finished dispensing fuel. In some instances, the fuel dispenser 104 may operate independently of the facility manager 152 for certain tasks and/or periods of time.

In the particular implementation of FIG. 1, the fuel dispenser 104 includes a management module 130, a device manager 128, one or more display(s) 116, which may include soft keys, a user input device 112 for managing peripheral elements, a dispenser computer 132, one or more additional components 124, and a multiplexer 144. In some implementations, including the particular implementation of FIG. 1, the management module 130 and the device manager 128 may be co-located on a single controller 126. The controller 126 may, for example, include a microprocessor, a memory, communications, an analog-to-digital converter, or a digital-to-analog converter. In other implementations, the management module 130 and the device manager 128 may be integrated. In still other implementations, the management module 130 and the device manager 128 may be separate components that are communicably coupled.

The management module 130 may be the main controller of the fuel dispenser, controlling the operations of the other components within the fuel dispenser 104, including the one or more display(s) 116, the user input device 112, the dispenser computer 132, and the additional components 124. In one instance, the management module 130 may be iX® Controller Electronics developed by Dresser-Wayne, Inc. of Austin, Tex. for use in fueling environments. Additionally, the management module 130 may also direct communication between the fuel dispenser 104 and the facility manager 152. To accomplish this, the management module 130 may control the functions of the fuel dispenser 104 through the generation and propagation of operational commands to the various components within the fuel dispenser 104. The management module 130 may also collect and maintain status information regarding the fuel dispenser 104 and report the status information to the facility manager 152. Additionally, the management module 130 may provide processing for the financial transaction required for a fueling session (e.g., a POS transaction), allowing the fuel dispenser 104 to dispense fuel. POS services could include cash register, dispenser control, transaction card processing, and/or bar code scanning. The management module 130 may be implemented in software, hardware, or a combination thereof.

The management module 130 may access memory 131, which may be random access memory (RAM), read-only memory (ROM), compact-disc read-only memory (CD-ROM), and/or any other appropriate information storage device. Memory 131 includes instructions 133, content 134, and logs 135. Instructions 133 dictate at least some of the operations of management module 130. Content 134 may be text, graphics, images, and/or video for presentation on display(s) 116. Content 134 may be presented in accordance with instructions 133. In some instances, a portion of the instructions 133 and the content 134 may reflect instructions received from the facility manager 152. Logs 135 may contain data regarding transactions (e.g., fueling sessions, financial payment, or otherwise) and errors. By analyzing logs 135, transactions may be recreated and analyzed and errors may be identified and assessed.

The management module 130 may, for example, be implemented as a rule engine. In such an implementation, instructions 133 may be rules (e.g., customer interaction rules and transaction processing rules), content 134 may store data for implementing the results of rules, and logs 135 may store data for processing the rules. Rule engines typically have a set of conditions that are precursors to a result being implemented. The conditions may also be preconditions to other conditions. Rule engine techniques that may be used for management module 130 includes those of JRules from ILOG, Inc. of Mountain View, Calif., Jess from Sandia National Laboratories of Livermore, Calif., or any other appropriate rule engine scheme. Management module 130 may be implemented using one or more programming and messaging technologies, including HTTP, TCP/IP, XML, SOAP, Universal Description, Discovery and Integration (UDDI), Microsoft .NET, or Java™. Portions of the module, for example, may be written in C++ in combination with other programming technologies (e.g., .NET) or any other appropriate technologies.

In some implementations, the management module 130 may be communicably coupled with and operate under the control of the facility manager 152. The facility manager 152 may provide instructions and/or requests to the management module 130 for content to be displayed to the customer, for handling point-of-sale transactions (e.g., verify and charge credit cards), and for providing any other appropriate services to the fuel dispenser. In these implementations, the instructions and/or requests from the facility manager 152 may be communicated to the management module 130 across the legacy communication line 148 coupling the fuel dispenser 104 with the facility manager 152.

Communications between the facility manager 152 and the fuel dispenser 104 across the legacy communication line 148 may comprise one or more multiplexed signals containing information in one or more communication protocols. For instance, the multiplexed signal may contain information in a legacy communication protocol as well as information in one or more advanced communication protocols (e.g., Ethernet). In order to receive and understand the multiplexed signal, the fuel dispenser 104 includes the multiplexer 144. In some implementations, the multiplexer 144 may be communicably coupled with the management module 130. In other implementations, the multiplexer 144 may be physically connected to, or a component of, the management module 130.

In the particular implementation of FIG. 1, the multiplexer 144 is capable of receiving legacy and Ethernet data from the management module 130 (across fuel dispenser legacy communication line 136 and fuel dispenser Ethernet communication line 140) intended for the facility manager 152, and multiplexing the data for transmission across the legacy communication line 148. The multiplexer 144 may, for example, be capable of frequency-division multiplexing (FDM). That is, the multiplexer 144 may assign a discrete carrier frequency to both the legacy data received across line 136 and the Ethernet data received across line 140. The multiplexer 144 may then combine the modulated carrier frequencies in a multiplexed signal for transmission over the legacy communication line 148. In the environment 100, only two carrier frequencies may be necessary, one for the legacy data and one for the Ethernet data. Other implementations, however, may include more carrier frequencies for additional communication protocols used to send data between the fuel dispenser 104 and the facility manager 152.

In addition to sending data to the facility manager 152 from the fuel dispenser 104, the multiplexer 144 may also receive communications from the facility manager 152 over the legacy communication line 148. When the data is received, the multiplexer 144 may demultiplex the transmission into discrete legacy and Ethernet carrier frequencies. Once demultiplexed, the multiplexer 144 may then transmit the separated legacy and Ethernet communications to the management module 130 for further processing. In some instances, the multiplexer 144 may be configured such that full duplex communication with the associated multiplexer 164 of the facility manager 152 may be established. In those instances, the multiplexer 144 may transmit a composite signal to the facility manager 152 while simultaneously receiving a composite signal from the facility manager 152. One benefit of full duplex communication is the efficient use of time in that the multiplexer 144 does not have to wait until it is done receiving information from the facility manager 152 before it transmits information to the facility manager 152.

Upon receiving the incoming signals from the facility manager 152, the management module 130 may analyze and process the data to determine the operational commands to be generated in order for the fuel dispenser 104 to perform operations consistent with the instructions provided from the facility manager 152. In some instances, the instructions provided from the facility manager 152 may be relayed to the components of the fuel dispenser 104 without requiring the generation of new operational commands. In those instances, the instruction received at the management module 130 may initially be received in the proper communication protocol associated with a specific component. However, in some instances, the management module 130 may receive and analyze the instructions to determine the operations at the fuel dispenser 104 needed to carry out the instruction and generate the operational commands necessary to perform those operations. In some instances, the management module 130 may access memory 131 for the relevant instructions 133 and/or content 134 to use in generating the operational commands.

Once the operational commands are generated, the management module 130 may transmit the operational commands to the device manager 128. The device manager 128 receives the operational commands addressed to particular components of the fuel dispenser 104 from the management module 130. The device manager 128 translates the operational commands into the proper communication protocol for the particular component(s) associated with the operational commands. Translating the operational commands may mean any change in the operational commands, not merely a literal or direct translation of the operational commands from one protocol to the other. For example, the device manager 128 may “translate” the operational commands generated by the management module 130 into a command signal. In this manner, the device manager 128 may act as a relay between the management module 130 and the individual components of the fuel dispenser 104. Because different types of components may be installed within the fuel dispenser 104, the management module 130 may not be able to directly communicate with each component in the communication protocol with which each particular component is compatible. Thus, the device manager 128 may translate the operational commands into the proper communication protocols and forward the translated commands to the associated component. For instance, the one or more display(s) 116 may only be compatible with one communication protocol (e.g., Ethernet). In situations where the instructions from the management module 130 are not provided in Ethernet, the one or more display(s) 116 would not be able to understand the instructions if communicating directly with the management module 130. In those situations, the device manager 128 translates and forwards the commands provided by the management module 130 to the one or more display(s) 116 for presentation at the fuel dispenser 104.

In addition to translating and forwarding the operational commands received from the management module 130 to the individual components of the fuel dispenser 104, the device manager 128 also receives responsive communications and data from the components before, during, or after the operational commands are performed. Again, the individual components communicate with the device manager 128 in the communication protocol associated with each component. Upon receiving the responsive communication and data, the device manager 128 translates the information into a communication protocol compatible with the management module 130. Once translated, the information is forwarded to the management module 130 for further processing and/or action. In this manner, the device manager 128 may act as a relay between the individual components and the management module 130.

The components included in the particular implementation of FIG. 1 include one or more display(s) 116, the user input device 112, the dispenser computer 132, and a set of one or more additional components 124. Each component may be communicably coupled to the device manager 128 in order to communicate with the management module 130. In some instances, all components may communicate in a single, uniform communication protocol. In other instances, each component may communicate in a different communication protocol from one or more of the other components within the fuel dispenser 104.

The one or more display(s) 116 provide instructions and other content received from the management module 130 (via the device manager 128) to the customer. The content displayed may be provided by the facility manager 152 and/or the management module 130. One example of the content provided by the display 116 includes a request for the input of a customer's personal identification number (PIN) data associated with a debit card used at the fuel dispenser 104. Other examples of the content displayed may include additional customer instructions, feedback regarding the current transaction, and questions for the customer, such as whether a receipt is requested or whether a car wash is desired. In other instances, the content provided may be various forms of multimedia or other rich content including, but not limited to, video, graphics, or an interactive display responsive to customer input, such as a website. In general, the display 116 itself may be any monitor (e.g., CRT) or screen (e.g., LCD) capable of receiving and visually presenting content to the customer. The fuel dispenser 104 may receive instructions and data for the display 116 in the form of legacy communications or, when multimedia or other advanced data may be desired, in the form of Ethernet communications, as well as in other communication protocols. In the present implementation, the management module 130 controls the data provided to each of the one or more display(s) 116.

The user input device 112 provides for and controls user inputs to the fuel dispenser 104. These inputs may include customer financial and/or personal data, such as payment information received at a card reader from a credit card or other payment method, as well as personal information received at a keypad, such as the customer's PIN. Additionally, input at the user input device 112 may include transactional selections such as the grade of fuel to be dispensed, the purchase of a carwash, or any other relevant information input at the fuel dispenser 104. The user input device 112 may collect and process the received information prior to providing the data to the management module 130 (via the device manager 128) for further action. The user input device 112 may be a keypad, a keyboard, a touchpad, a touch screen, a card reader, or any other appropriate device for allowing a user to provide an indication to the fuel dispenser 104.

The dispenser computer 132 may control fuel storage tank submersible pumps and fuel control valves and monitor fuel flow information via metering and reporting subsystems (e.g., totals by grade, errors, etc.). The management module 130 may interoperate with the dispenser computer 132 to deliver commands and receive transaction data and status. Additionally, the management module 130 (via the device manager 128) may issue commands to the dispenser computer 132 over the fuel dispenser's 104 internal connections. Control, status, real-time diagnostic, error codes and data may also be exchanged over the internal communications of the fuel dispenser 104. The dispenser computer 132 may control the hydraulic elements of the dispenser 104 used to provide fuel dispensing functionality. The dispenser computer 132 may also drive sale progress displays on the sales/volume displays of the dispenser 104. The management module 130 may collect and maintain the status of the fuel dispenser 104 and report the status information to the facility manager 152 over the legacy communications line 148.

The fuel dispenser 104 may include a set of additional components 124 providing further functionality to the fueling environment 100. Some examples of these additional components may include a barcode reader, a biometric input system, a receipt printer, and an RFID reader (e.g., Speedpass). The additional components 124 may provide enhanced customer interaction with the fuel dispenser 104, and may act in response to commands provided by the facility manager 152 or the management module 130 (via the device manager 128). The fuel dispenser 104 may receive instructions and data from the facility manager 152 for the one or more additional components 124 in the form of legacy communications, or, when multimedia or other advanced data may be desired, in the form of Ethernet (or other advanced) communications. In the present implementation, the management module 130 controls the data provided to each of the additional components 124.

Moving outside the fuel dispenser 104, the facility manager 152 provides a location at which the fueling environment 100 may be monitored and controlled. In some instances, the facility manager 152 may be in the in-store environment of a gas station, while in others it may be a standalone facility. The facility manager 152 may be embodied by one or more servers, personal computers, or any other appropriate devices for interacting with and controlling the fuel dispenser 104.

As illustrated, the facility manager 152 includes a facility controller 156, a router 160, a controller gateway 168, and a multiplexer 164. The components may be formed in a single, integrated component capable of performing the tasks of each illustrated component, or one or more of the components may be communicably coupled to each other such that they communicate to fulfill the operations of the facility manager 152.

Multiplexer 164 provides the communication functionality for the facility manager 152, allowing the sending and receiving of multiplexed information across the legacy communication line 148. The multiplexer 164 may be communicably coupled to the facility controller 156 and the router 160. As described below, the facility controller 156 and the router 160 may provide information in different formats. For example, the facility controller 156 may provide information using serial communications over an RS-422 or RS-485 connection, while the router 160 may provide advanced data (e.g., Ethernet) across another appropriate connection (e.g., CAT-3 or CAT-5). Upon receiving data from the facility controller 156 and/or the router 160, the multiplexer 164 may use multiplexing techniques such as FDM to assign a discrete carrier frequency to each set of data and combine them into a single transmission sent across the legacy communication line 148. Although illustrated in FIG. 1 as receiving serial and Ethernet communications, in some implementations the multiplexer 164 may receive data in additional communication protocols, wherein each additional protocol may be assigned a new carrier frequency and may be included within the transmissions to and from the fuel dispenser 104.

In addition to combining data for transmission, the multiplexer 164 may also receive communications across the legacy communication line 144 from multiplexer 144 of the fuel dispenser 104. In those instances, the multiplexer 164 may demultiplex the signals received into the discrete carrier frequencies within the transmission. Once demultiplexed, the multiplexer 164 may supply the legacy serial data to the facility controller 156 and the advanced data (e.g., Ethernet) to the router 160. Those components may then further process the data to perform the fueling environment's 100 operations (e.g., fuel dispensing, credit card processing, etc.). In some instances, the multiplexer 164 may be configured such that full duplex communication with the associated multiplexer 144 of the fuel dispenser 104 may be established. In those instances, the multiplexer 164 may transmit a composite signal to the fuel dispenser 104 while simultaneously receiving a composite signal from the fuel dispenser 104.

Facility controller 156 typically includes a processor (e.g., a microprocessor, a microcontroller, or any other appropriate device for manipulating information in a logical manner) and memory (e.g., RAM, ROM, CD-ROM, programmable read-only memory (PROM), a hard drive, and/or any other appropriate information storage device) that stores instructions and/or data for the processor. The instructions may, for example, include an operating system (e.g., Linux, Unix, or Windows) and applications (e.g., fuel dispenser control, accounting, and diagnostics). Facility controller 156 may, for example, provide authorization, financial transaction, and fuel dispensing management for the one or more fuel dispensers of environment 100. Additionally, the facility controller 156 may be communicably coupled to a credit/debit network 180 to allow for authentication of customers' payment information with the appropriate authority, such as Visa, MasterCard, or a clearinghouse. In some instances, the facility controller 156 may also be communicably coupled to other networks to perform other operations such as authenticating customers' personal information received from drivers licenses or other identification cards. Communications with the credit/debit network 180 may be performed using any suitable communication type including Internet, dial-up connections, and satellite communications, among others. While the facility controller 156 may perform a plurality of functions in the fueling environment 100, the controller's communications with the fuel dispenser 104, including operational instructions and transactional data, may be made using a legacy method, such as serial communications.

The facility manager 152 also includes a controller gateway 168 capable of generating and controlling additional communications with the fuel dispenser 104. The controller gateway 168 may be a server, a personal computer, or any other device capable of receiving and generating information for use in the fueling environment 100. As illustrated, the controller gateway 168 may be communicably coupled to the router 160, which in turn is connected to the information network 184. The router 160 may be any device capable of acting as a junction between an information network 184 (e.g., the Internet) and the communications within the fueling environment 100. Using the information network 184, the router 160 may connect the controller gateway 168 to a centralized network, system, or server providing business rules, advertising, media, or other information to be distributed in the fueling environment 100. Additionally, using the router 160, the controller gateway 168 may connect to the Internet or other information network 184 such that content and other instructions may be retrieved or sent. In some instances, information received at the controller gateway 168 may be provided to the facility controller 156, while in others, media, advertising, and other communications may be provided to the fuel dispenser 104 over the legacy communication line 148 upon processing by the multiplexer 164. Reporting, status, and other information may be sent from the management module 130 to the controller gateway 168 for analysis, processing, and storage. In some instances, the controller gateway 168 may independently generate content and/or instructions for the management module 130 to be sent across the legacy communication line 148. Content received from the controller gateway 168 by the router 160 may be sent to the multiplexer 164 for transmission to the fuel dispenser 104. Such information may be sent over an advanced (e.g., Ethernet) connection communicably coupling the multiplexer 164 and the router 160. Once received at the multiplexer 164, the information may be processed by the multiplexer 164 in order for the advanced communication protocol-based instructions to be provided across the legacy communication line 148 with the serial communications from the facility controller 156.

The information network 184 may be all or a portion of an enterprise or secured network. In some instances, a portion of the information network 184 may be a virtual private network (VPN) between the router 160 and a centralized server (not illustrated) operated by either the owner/operator of the facility manager 152 or a third party. The router's 160 connection to the information network 184 may be embodied by a wireline or wireless link. Such an example wireless link may be via IEEE 802.11, WiMax, IS-95, IS-136, and many others. Additionally, the information network 184 may include one or more local area networks (LANs), radio access networks (RANs), wide area networks (WANs), all or a portion of the Internet, and/or any other communication system or systems at one or more locations.

The architecture illustrated by FIG. 1 has a variety of features. For example, as operators demand better performance and greater capabilities in their fueling facilities 100, both fuel dispensers 104 and facility managers 152 may be modified to increase the speed, amount, and types of information communicated between the locations without having to undertake cumbersome structural changes. For instance, advertisements, multimedia, and other advanced communications may be desired at the fuel dispenser 104. Because many current systems provide only the legacy communication line 148 for communication between the fuel dispenser 104 and the facility manager 152, operators have been forced to install additional communication lines to carry the new data. In order to provide increased functionality and communications between the fuel dispenser 104 and the facility manager 152, FIG. 1 illustrates an architecture and technique for transmitting legacy information and advanced information across the legacy communication line 148 without adding a dedicated communication line between the components for advanced communications.

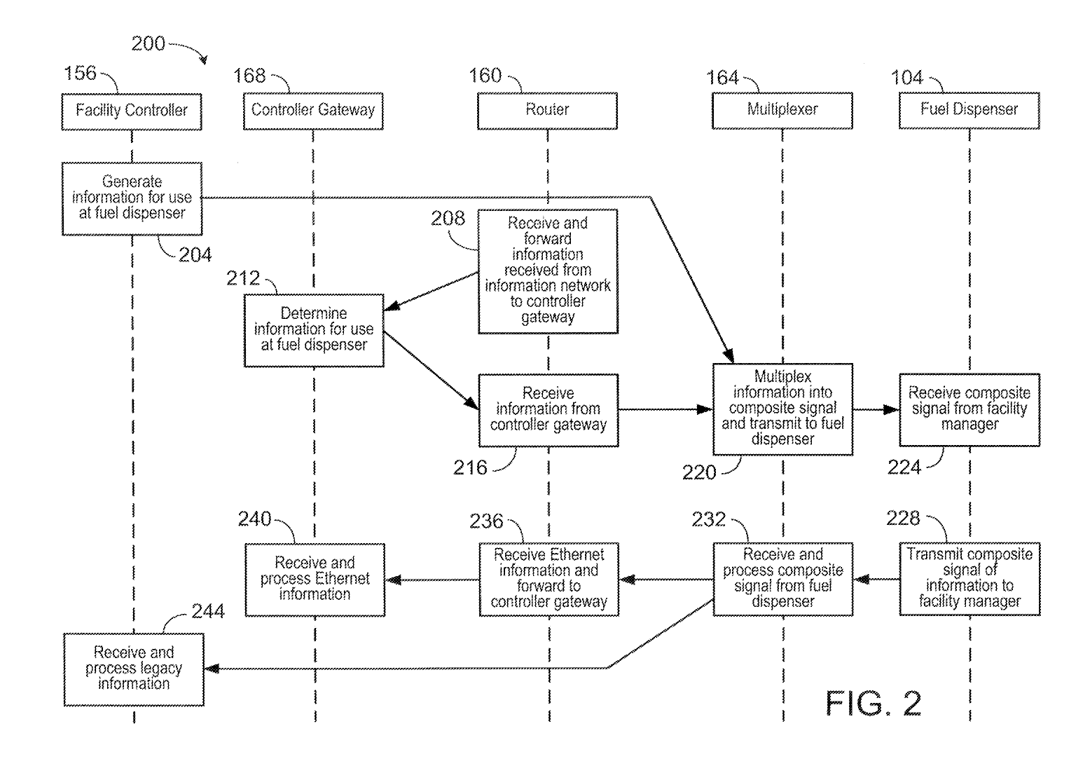

FIG. 2 illustrates a sequence from the perspective of a facility manager 152 for a process 200, in which legacy and advanced communication protocol (in this instance, Ethernet) data may be transmitted across a legacy communication line. At operation 204, the facility controller 156 generates information (e.g., commands, instructions, and/or data) for use (e.g., processing or displaying) at the fuel dispenser 104. In some instances, the information may generally relate to the actions to be performed at fuel dispensers 104, such as the payment process, fuel dispensing, and other functions. Once the information has been generated, the facility controller 156 may transmit the data to the multiplexer 164 via the internal connections of the facility manager 152.

At operation 208, the router 160 may receive information (e.g., commands, and/or data) from the information network 180 for the controller gateway 168. This data may include updated system and operating information for the facility manager 152, commands for the fuel dispenser 104, remote diagnostic requests for the fuel dispenser 104, or other information relating to one or more of the components within the fueling environment 100. Upon receiving the data, the router 160 may forward the information to the controller gateway 168. At operation 212, the controller gateway 168 may determine (e.g., select and/or generate) information from the information received from the router 160 for use (e.g., processing or display) at the fuel dispenser 104, such as commands, instructions, and various data such as media or other rich content. The controller gateway 168 may then send the information to the router 160 for transmission to the multiplexer 164. At operation 216, the router 160 may receive the information from the controller gateway 168 and forward it to the multiplexer 164.

At operation 220, the information from the facility controller 156 and the controller gateway 168 may be received at the multiplexer 164 and multiplexed into a composite signal. As previously described, the multiplexer 164 may assign a discrete carrier frequency to each set of data. Once frequencies are assigned, the multiplexer 164 may combine them into one signal and transmit the data across the legacy communication line 148. At operation 224, the fuel dispenser 104 may receive the composite signal from the facility manager 152. After sending the composite signal, the facility manager 152 may perform other operations until the fuel dispenser 104 communicates to the facility manager 152, perhaps in response to a command.

At operation 228, the fuel dispenser 104 transmits multiplexed information containing both legacy and Ethernet information across the legacy communication line to the facility manager 152. This information is received and processed at the multiplexer 164 at operation 232. Processing may include demultiplexing, or separating, the composite signal into its discrete carrier frequencies, and, once separated, providing the information associated with the Ethernet output to the router 160 and the information associated with the legacy output to the facility controller 156. At operation 236, the router 160 receives the Ethernet data from the multiplexer 164 and forwards it to the controller gateway 168. At operation 240, the controller gateway 168 may receive and process the Ethernet data. At operation 244, the facility controller 156 may receive and process the legacy data received from the multiplexer 164. Upon completion of illustrated process 200, the facility manager 152 may return to operations 204 or 208 to generate or receive additional commands, or to operation 228 if more data is received from the fuel dispenser 104.

It will be understood that the order of the operations in FIG. 2 are for illustration purposes only and that the described or similar techniques may be performed at any appropriate time, including concurrently, individually, or in combination. Additionally, many of the operations may take place simultaneously and/or in different orders than as shown. In some instances, operations 220 and 232 may occur simultaneously, such that the multiplexer 164 of the facility manager 152 may be both transmitting and receiving information at the same time. This simultaneous transmission may occur in embodiments where the multiplexer 164 is adapted for full duplex communication with the fuel dispenser 104. In some embodiments, upon completion of operation 224, process 200 may return to operation 204 and determine additional information for use at the fuel dispenser 104. Additionally, in some instances some operations may not be present during one or more iterations of process 200. For example, information may not be received from the router 160 in some instances. So long as the process 200 remains appropriate, additional, fewer, or different operations may occur than illustrated in FIG. 2.

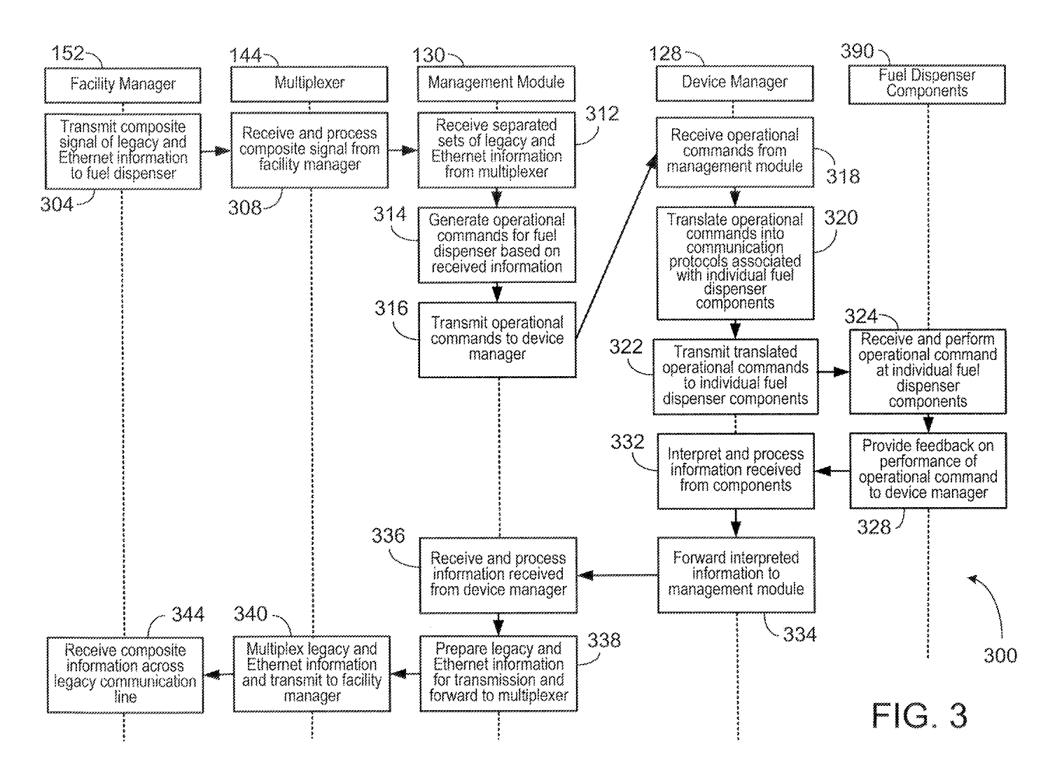

FIG. 3 illustrates a sequence from the perspective of the fuel dispenser 104 for a process 300 in which communications in both a legacy and an advanced communication protocol (in this instance, Ethernet) may be transmitted and received across the legacy communication line 148. At operation 304, the facility manager 152 transmits a composite (or multiplexed) signal of legacy and Ethernet information over the legacy communication line 148 to the fuel dispenser 104. At operation 308, the multiplexer 144 at the fuel dispenser 104 receives and processes the received composite signal. Similar to operation 232 of FIG. 2, the multiplexer 144 processes the composite signal by demultiplexing the signal using its discrete carrier frequencies to receive discrete signals for both the legacy and Ethernet information. Once demultiplexed, the information from the discrete signals may be transmitted to the management module 130 across internal communication lines 136 (legacy data) and 140 (Ethernet data).

At operation 312, the management module 130 receives and processes the legacy and Ethernet information. Processing the information may include analyzing both the legacy and Ethernet information for the instructions and requests sent by the facility manager 152. At operation 314, the management module 130 generates operational commands for the fuel dispenser 104 based upon the data received from the facility manager 152. To do so, the management module 130 may access the memory 131 to retrieve the instructions 133 or content 134 needed to complete the instructions and tasks requested by the facility manager 152. Each operational command may be addressed to specific individual components within the fuel dispenser 104. By addressing each of the commands, multiple functions occurring at one or more components may be included in one set of operational commands. In some instances, the instructions from the facility manager 152 may be in a form compatible with the fuel dispenser 104 such that the management module 130 need not generate a new set of operational commands. In those instances, the management module 130 may use the commands received from the facility manager 152 as the fuel dispenser's 104 operational commands. When the set of operational commands has been generated or selected, the management module 130 may then transmit the operational commands to the device manager 128 for further action at operation 316.

At operation 318, the device manager 128 receives the operational commands from the management module 130. Once received, the device manager 128 translates the operational commands from the management module 130 into the communication protocols associated with the individual component to which the commands are addressed at operation 320. In some instances, every component may use the same communication protocol, while in other instances, each component may use a distinct protocol to communicate within the fuel dispenser 104. The device manager 128 is aware of the various protocols used by each component and translates the operational commands as necessary. Once the operational commands are translated and ready for delivery, at operation 322 the device manager 128 transmits the operational commands to the individual fuel dispenser components.

At operation 324, operational commands from the device manager 128 may be received at one or more fuel dispenser components 390. Once the operational commands and content are received, the individual components 390 may perform the actions corresponding to the instructions. Once the commands and content have been processed and performed, the fuel dispenser components may provide feedback or other information (e.g., customer input, status update, etc.) to the device manager 128 at operation 328. In some instances, the operational commands may request certain feedback from the fuel dispenser components 390, while in other instances, the messages and feedback may be a reflection of the action taken by the component 390.

At operation 332, the device manager 128 receives and interprets the data provided by the fuel dispenser components 390 prior to providing the information to the management module 130. Interpreting the information may comprise translating the data into a communication protocol or form compatible with the management module 130. In some instances, interpreting the information may not be necessary due to communication compatibility between the management module 130 and a specific fuel dispenser component 390. Once the information is in an acceptable form, the device manager 128 may forward the information to the management module 130 at step 334. In some instances, the device manager 128 may forward information to the management module 130 as soon as it has been interpreted. In other instances, the device manager 128 may wait for the entire set of responsive data to be received and translated before forwarding information on to the management module 130.

At operation 336, the management module 130 receives and processes the information from the device manager 128. Processing may include generating additional commands for one or more of the fuel dispenser components 390, such as instructions to the dispenser computer 132, sending payment information to the facility manager 152 for authorization, and other fueling environment actions. Once the data has been processed, at operation 338 the management module 130 may prepare the information for transmission to the facility manager 152 and forward the information to the multiplexer 144 for delivery to the facility manager 152. Preparing the information may include determining to which component of the facility manager 152 the data should be sent and what format the data should be sent in. Once prepared, the management module 130 may provide the legacy and Ethernet data to the multiplexer 144 across the internal legacy 136 and Ethernet 140 transmission lines at operation 338.

At operation 340, the multiplexer 144 receives the information from the management module 130, multiplexes the legacy and Ethernet data as previously described, and transmits the composite signal to the facility manager 152 across the legacy communication line 148. At operation 344, the facility manager 152 receives the data and may perform process 200. When more information is transmitted to the fuel dispenser 104 from the facility manager 152, process 300 may return to operation 304. If additional data is generated by the fuel dispenser components 390, then process 300 may return to operation 328.

It will be understood that the order of the operations in FIG. 3 are for illustration purposes only and that the described or similar techniques may be performed at any appropriate time, including concurrently, individually, or in combination. Additionally, many of the operations may take place simultaneously and/or in different orders than as shown. In some instances, operations 308 and 340 may occur simultaneously, such that the multiplexer 144 of the fuel dispenser 104 may be both multiplexing/transmitting and demultiplexing/receiving at the same time. In those instances, the multiplexer 144 is adapted for full duplex communication with the facility manager 152. In still other instances, upon completion of operation 320, process 300 may return to operation 304 and transmit additional information over the legacy communication line 148 to the fuel dispenser 104. Additionally, in some instances some operations may not be present during one or more iterations of process 300. For example, the management module 130 may not generate operational commands at operation 314, such as when the facility manager 152 provides its commands in a usable form. So long as the process 300 remains appropriate, additional, fewer, or different operations may occur than illustrated in FIG. 3.

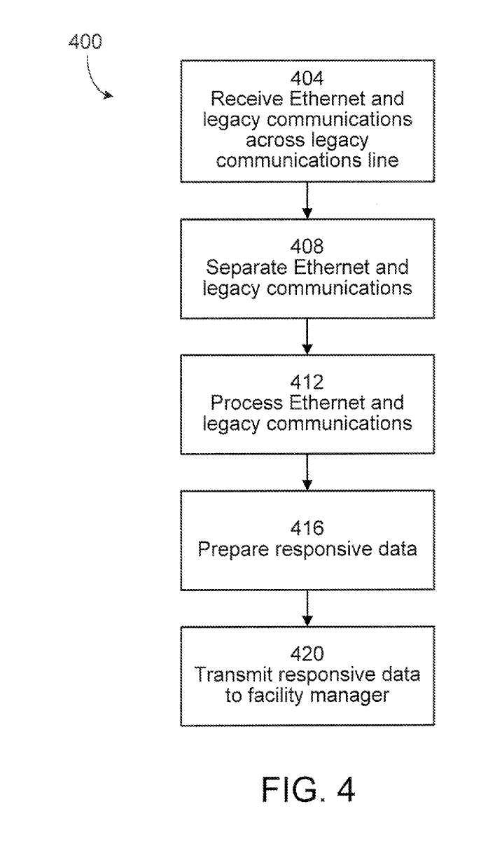

FIG. 4 illustrates one example of a process 400 that occurs at the fuel dispenser 104 when information is received across the legacy communication line 148 according to the illustrated implementation of FIG. 1. At operation 404, the fuel dispenser 104 receives a composite, or multiplexed, signal comprised of legacy and Ethernet (or another advanced communication protocol) information across the legacy communication line 148. The legacy information may be transmitted at a low frequency within the composite signal, while the Ethernet information may be simultaneously transmitted at a discretely higher frequency. At operation 408, the fuel dispenser 104 may demultiplex the composite signal into separate carrier frequencies such that the legacy and Ethernet data may be separately processed. At operation 412, the fuel dispenser 104 may process the data, including any commands, instructions, or content therein. Processing the data may include analyzing the data and performing the specified operations. Once the information has been processed, a responsive set of data may be prepared by the fuel dispenser 104, which in some instances may include a combination of legacy and Ethernet data. Preparing the responsive set of data may include generating a composite signal providing a multiplexed combination of the legacy and Ethernet data. At operation 420, the fuel dispenser 104 may transmit the set of responsive data to the facility manager 152 across the legacy communication line 148.

While the preceding flowcharts, sequence diagrams, and accompanying descriptions illustrate exemplary processes 200, 300, and 400, the fueling environment 100 contemplates using or implementing any suitable technique for performing these and other tasks. It will be understood that these methods are for illustration purposes only and that the described or similar techniques may be performed at any appropriate time, including concurrently, individually, or in combination. In addition, many of the operations in these flowcharts may take place simultaneously and/or in different orders than as shown. Moreover, the system 100 may use methods with additional operations, fewer operations, and/or different operations, so long as the process remains appropriate.

Although this disclosure has been described in terms of certain implementations and generally associated processes, alterations and permutations of these implementations and processes will be apparent to those skilled in the art. Accordingly, the above description of example implementations does not define or constrain the disclosure. Other changes, substitutions, and alterations are also possible while still achieving fueling facility communications. For at least these reasons, the protected subject matter is to be measured by the following claims, which may encompass one or more aspects of one or more of the implementations or processes.

What is claimed is:

1. A fuel dispenser, comprising:
a management module for controlling the functions of the fuel dispenser;
a multiplexing device coupled to the management module, the multiplexing device adapted to:
receive a composite signal comprising a first set of information in a first communication protocol and a second set of information in a second communication protocol;
demultiplex the composite signal into the first and the second set of information; and
transmit the first and the second set of information to the management module;
a device manager coupled to the management module, the device manager adapted to:
receive commands generated by the management module in response to the first and second sets of information;
translate at least one of the commands into a first operational command for a first fuel dispenser component, the first operational command formatted according to a third communication protocol;
translate at least one of the commands into a second operational command for a second fuel dispenser component, the second operational command formatted according to a fourth communication protocol;
the first fuel dispenser component coupled to the device manager, the first fuel dispenser component adapted to receive and perform the first operational command; and
the second fuel dispenser component coupled to the device manager, the second fuel dispenser component adapted to receive and perform the second operational command.

2. The fuel dispenser of claim 1, wherein the first communication protocol is RS-485 and the second communication protocol is Ethernet.

3. The fuel dispenser of claim 2, wherein the third communication protocol is RS-485 and the fourth communication protocol is Ethernet.

4. The fuel dispenser of claim 2, wherein the third communication protocol is not RS-485 and the fourth communication protocol is not Ethernet.

5. The fuel dispenser of claim 1, wherein the multiplexing device uses frequency-division multiplexing.

6. The fuel dispenser of claim 1, wherein the composite signal is received over a twisted pair of wires.

7. The fuel dispenser of claim 1, wherein the first fuel dispenser component is a card reader and the second fuel dispenser component is a display.

8. The fuel dispenser of claim 1, wherein the multiplexing device is further adapted to receive a composite signal comprising information in more than two communication protocols.

9. The fuel dispenser of claim 1, wherein the management module comprises a point-of-sale module for providing point-of-sale operations at the fuel dispenser.

10. The fuel dispenser of claim 1, the device manager further adapted to receive commands generated by the management module based upon content and instructions stored in a memory associated with the management module.

11. A communication method for a fuel dispenser comprising:
receiving a composite signal comprising information in a first communication protocol and information in a second communication protocol;
separating the composite signal into the first communication protocol and the second communication protocol; and
processing the separated first and second communication protocol signals.

12. The method of claim 11, wherein processing the first and second communication protocols comprises sending the separated first and second communication protocol to a management module.

13. The method of claim 12, wherein processing the first and second communication protocols further comprises:
generating operational commands by the management module in response to the information in the first and second communication protocols;
sending the operational commands to the device manager for translation of at least one of the commands into a third communication protocol compatible with a first fuel dispenser component and at least one of the commands into a fourth communication protocol compatible with a second fuel dispenser component.

14. The method of claim 13, wherein the first fuel dispenser component is a card reader.

15. The method of claim 13, wherein the second fuel dispenser component is a display.

16. The method of claim 11, wherein the first communication protocol is RS-485 and the second communication protocol is Ethernet.

17. The method of claim 11, wherein the composite signal comprising information in the first communication protocol and information in the second communication protocol is a multiplexed signal generated using frequency-division multiplexing.

18. The method of claim 11, wherein separating the composite signal comprises demultiplexing the signal into the first and second communication protocols.

19. The method of claim 11, wherein the composite signal is received across a twisted pair of wires.

20. A communication method for a fueling facility, comprising:
generating a first set of information in a first communication protocol and a second set of information in a second communication protocol at a facility manager;
combining the first set of information and the second set of information into a combined signal at the facility manager;
transmitting the combined signal from the facility manager to a fuel dispenser;
receiving the combined signal at the fuel dispenser;
separating the combined signal into the first set of information in the first communication protocol and the second set of information in the second communication protocol; and
processing the first and second set of information at the fuel dispenser.

21. The method of claim 20, wherein the first communication protocol is RS-485 and the second communication protocol is Ethernet.

22. The method of claim 20, wherein combining the first and second set of information comprises multiplexing the first and second set of information into a combined signal.

23. The method of claim 20, wherein separating the first and second set of information comprises demultiplexing the combined signal into the first and second set of information.

24. The method of claim 23, wherein the combined signal is multiplexed using frequency-division multiplexing.

25. The method of claim 20, wherein the combined signal is transmitted from the facility manager to the fuel dispenser across a twisted pair of wires.
